(19) United States
(12) Patent Application Publication
(10) Pub. No.: US 2024/0061135 A1
(43) Pub. Date: Feb. 22, 2024

(54) TIME-TO-DEPTH SEISMIC CONVERSION USING PROBABILISTIC MACHINE LEARNING

(71) Applicant: SAUDI ARABIAN OIL COMPANY, Dhahran (SA)

(72) Inventor: Youness El Ouair, Dhahran (SA)

(73) Assignee: SAUDI ARABIAN OIL COMPANY, Dhahran (SA)

(21) Appl. No.: 17/821,389

(22) Filed: Aug. 22, 2022

(51) Int. Cl. G01V 1/34; G01V 1/30

(52) U.S. Cl. CPC G01V 1/345; G01V 1/303; G01V 2210/1295; G01V 2210/1425; G01V 2210/6222; G01V 2210/74

(57) ABSTRACT

A method and system for forming a depth-domain seismic image using a predicted seismic velocity model is disclosed. The method includes obtaining a first surface seismic dataset of a subterranean region and obtaining a measured seismic velocity profile through the subterranean region for a surface location. The method also includes determining a set of seismic attributes for the surface location from the first surface seismic dataset, and training, using the measured seismic velocity profile and the set of seismic attributes, a machine-learning network to predict a predicted seismic velocity profile from the set of seismic attributes, wherein the predicted seismic velocity profile is an estimate of the measured seismic velocity profile. The method further includes determining a set of seismic attribute volumes from a second surface seismic dataset, and predicting a seismic velocity model for the subterranean region, using a trained machine-learning network and the set of seismic attribute volumes.

### BACKGROUND

In the oil and gas industry, seismic surveying is used to image the subsurface. Seismic images play an important role in determining the presence of hydrocarbon reservoirs. Surface seismic data is recorded in the two-way seismic travel-time domain and is typically converted from the time domain to the depth domain using seismic velocity models. Time-to-depth conversion of surface seismic data may be inaccurate and/or have higher levels of uncertainty where seismic velocity information is inaccurate. Quantifying the uncertainty associated with the depths of geological features in seismic images is important to understanding risk when locating and drilling for hydrocarbons reservoirs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to methods for forming a depth-domain seismic image using a predicted seismic velocity model. The methods include obtaining a first surface seismic dataset of a subterranean region and obtaining a measured seismic velocity profile through the subterranean region for a surface location. The methods also include determining a set of seismic attributes for the surface location from the first surface seismic dataset, and training, using the measured seismic velocity profile and the set of seismic attributes, a machine-learning network to predict a predicted seismic velocity profile from the set of seismic attributes, wherein the predicted seismic velocity profile is an estimate of the measured seismic velocity profile. The methods further include determining a set of seismic attribute volumes from a second surface seismic dataset, and predicting a seismic velocity model for the subterranean region, using a trained machine-learning network and the set of seismic attribute volumes.

In general, in one aspect, embodiments disclosed herein relate to a non-transitory computer readable medium storing a set of instructions, executable by a computer processor, the set of instructions including functionality for receiving a first surface seismic dataset of a subterranean region and receiving a measured seismic velocity profile through the subterranean region for a surface location. The set of instructions also includes functionality for determining a set of seismic attributes for the surface location from the first surface seismic dataset, and training, using the measured seismic velocity profile and the set of seismic attributes, a machine-learning network to predict a predicted seismic velocity profile from the set of seismic attributes, wherein the predicted seismic velocity profile is an estimate of the measured seismic velocity profile. The set of instructions further includes functionality for determining a set of seismic attribute volumes from a second surface seismic dataset, and predicting a seismic velocity model for the subterranean region, using a trained machine-learning network and the set of seismic attribute volumes.

In general, in one aspect, embodiments disclosed herein relate to a system, including a seismic acquisition system and a computer system. The seismic acquisition system is configured to obtain a first surface seismic dataset of a subterranean region and obtain a measured seismic velocity profile through the subterranean region for a surface location. The computer system is configured to receive the first surface seismic dataset and to receive a measured seismic velocity profile through the subterranean region for a surface location. The computer system is also configured to determine a set of seismic attributes for the surface location from the first surface seismic dataset, and train, using the measured seismic velocity profile and the set of seismic attributes, a machine-learning network to predict a predicted seismic velocity profile from the set of seismic attributes, wherein the predicted seismic velocity profile is an estimate of the measured seismic velocity profile. The computer system is further configured to determine a set of seismic attribute volumes from a second surface seismic dataset, and predict a seismic velocity model for the subterranean region, using a trained machine-learning network and the set of seismic attribute volumes.

Other aspects and advantages of the claimed subject matter will be apparent from the following description and the appended claims.

### BRIEF DESCRIPTION OF DRAWINGS

FIG. 1 depicts a surface seismic survey in accordance with one or more embodiments.

FIG. 2A depicts a borehole seismic survey in accordance with one or more embodiments.

FIG. 2B shows a borehole seismic dataset in accordance with one or more embodiments.

FIG. 3 illustrates an artificial neural network in accordance with one or more embodiments.

FIG. 4 shows examples of probability distributions in accordance with one or more embodiments.

FIG. 5A shows a kernel matrix in accordance with one or more embodiments.

FIG. 5B shows sampled functions in accordance with one or more embodiments.

FIG. 5C shows a prior in accordance with one or more embodiments.

FIG. 5D shows a posterior in accordance with one or more embodiments.

FIG. 5E shows a probabilistic function in accordance with one or more embodiments.

FIG. 6 shows a flowchart in accordance with one or more embodiments.

FIG. 7 depicts a seismic interpretation workstation displaying a mean of predicted velocities and a standard deviation of predicted velocities in accordance with one or more embodiments.

FIGS. 8A-8C show expected values in accordance with one or more embodiments.

FIG. 9 shows a plot of expected depth with associated uncertainties in accordance with one or more embodiments.

FIG. 10 depicts a drilling system in accordance with one or more embodiments.

FIG. 11 depicts a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

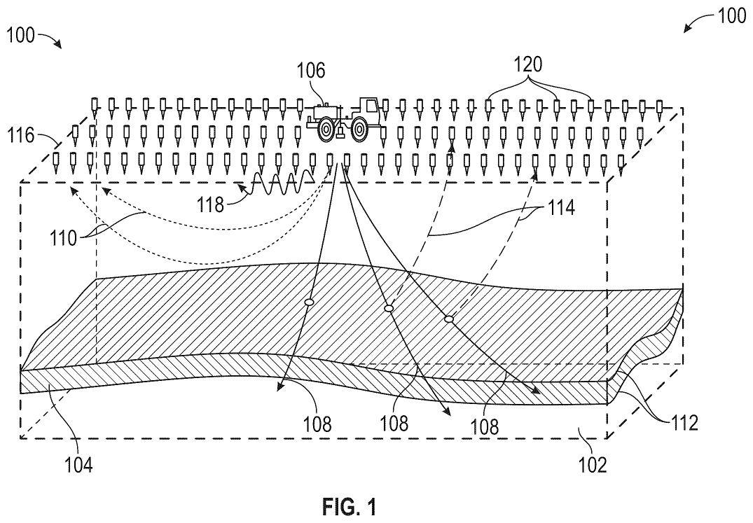

In the following description of FIGS. 1-11, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a borehole seismic dataset” includes reference to one or more of such borehole seismic datasets.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims may not be introduced, it would be apparent to one of ordinary skill that the subject matter of the dependent claims directed to one or more embodiments may be combined with other dependent claims.

While the terms “borehole” and “wellbore” are often used synonymously, the wellbore may refer to the drilled hole including the cased portion, whereas the borehole may not include the casing and may refer to the diameter of the open hole itself. Throughout the present disclosure, the terms wellbore and borehole are used synonymously.

The time-to-depth conversion of seismic products, such as seismic images, geological horizons, or other seismic attributes, requires accurate seismic velocity information across the entire subterranean region. Seismic velocity information may be obtained at sparse intervals from borehole seismic surveys recorded at wellbore locations within a two-dimensional (2D) or three-dimensional (3D) region of interest. The 2D measured velocity profile derived from borehole seismic data must be extrapolated from or interpolated between wellbore locations in order to create a well-sampled 3D seismic velocity model covering the full extent of the subterranean region. Alternatively, a well-sampled 3D seismic velocity model may be estimated from surface seismic data; however, this seismic velocity model is often less accurate when compared to the seismic velocity profiles measured from borehole seismic data at corresponding wellbore locations. To remedy this inaccuracy, estimated surface-seismic velocity models often require calibration using well information, but this remedy may only be partially effective due to the sparsity of wellbore locations. The disclosed embodiments provide a method for combining surface seismic and borehole seismic data that is an improvement over existing methods. In addition, uncertainties associated with the determinations of the depths of subsurface geological features may be quantified.

More specifically, embodiments disclosed provide a workflow for predicting a seismic velocity model from seismic datasets and their attributes using a machine-learning (ML) network. The embodiments disclose training a network, such as an artificial neural network (hereinafter also “a neural network”), implemented on a computer processor. This training uses data from a set of surface locations that have both borehole seismic and surface seismic information. The embodiment further describes applying the trained network to an entire subterranean region which includes surface locations that have surface seismic information but that may not have borehole seismic information. Gaussian process regression and Bayesian inference, or both, may be used within the workflow. The methods, in some embodiments, may produce a time-to-depth-converted seismic image (or “depth-domain seismic image”) with associated measures of uncertainty. In other embodiments, the seismic velocity model may be implemented to form a depth-domain seismic image directly from a seismic dataset. Further, the depth-domain seismic image may be used to locate hydrocarbon reservoirs. Methods are disclosed for planning and drilling wellbore paths based on the hydrocarbon reservoir locations.

FIG. 1 depicts a surface seismic survey (100) of a subterranean region of interest (102), which may contain hydrocarbon reservoir (104). The surface seismic survey (100) may use a seismic source (106) that generates radiated seismic waves (108). In a land environment, the seismic source (106) may be a dynamite source or one or more seismic vibrators (e.g., a “vibroseis truck”). In a marine or lacustrine environment, the seismic source (106) may be an air gun. The radiated seismic waves may be recorded by a plurality of seismic receivers (120). A single activation of the seismic source (106) may be recorded by tens or hundreds of thousands of seismic receivers (120). In a land environment, the seismic receiver may record the velocity or acceleration of ground motion. In a marine or lacustrine environment, the seismic receiver (120) may record pressure fluctuations caused by the radiated seismic waves (108).

The radiated seismic waves (108) may propagate along the ground surface (116) as surface waves (“ground-roll”) (118), or the radiated seismic waves (108) may also propagate below the surface (116) and return as refracted seismic waves (110) or may be reflected one or more times by geological discontinuities (112) before returning to the surface as reflected seismic waves (114).

The refracted seismic waves (110) and reflected seismic waves (114) generated by a single activation of the seismic source (106) are recorded by a seismic receiver (120) as a time-series representing the amplitude of ground-motion at a sequence of discrete times. This time-series may be denoted a seismic “trace.” A seismic source (106) is positioned at a location denoted (xₛ, yₛ) where x and y represent orthogonal axes on the surface (116) of the Earth above the subterranean region of interest (102). The seismic receivers (120) are positioned at a plurality of seismic receiver locations which we may denote (xᵣ, yᵣ). Thus, the refracted seismic waves (110) and reflected seismic waves (114) generated by a single activation of the seismic source (106) may be represented as a 3D volume with axes D (t, xᵣ, yᵣ) where (xᵣ, yᵣ) represents the location of the seismic receiver (120) and t denotes the time series at which the amplitude of ground-motion was measured. However, a surface seismic survey (100) may include recordings of seismic waves generated by a seismic source (106) that is positioned at a plurality of seismic source locations denoted (xₛ, yₛ). Thus, the seismic volume for a surface seismic survey (100) may be represented as a five-dimensional volume, denoted D (t, xᵣ, yᵣ, xₛ, yₛ), where (xᵣ, yᵣ) are vectors of seismic receiver locations along the x- and y-axes, and (xₛ, yₛ) are vectors of seismic source locations along the x- and y-axes.

The data collected by the surface seismic receivers (120) may referred to as a surface seismic dataset, or in general (without consideration of the location of the receivers), a seismic dataset. A seismic dataset may be arranged or “sorted” in many configurations. For example, seismic traces originating from a single seismic source location (xₛ, yₛ) may be selected and sorted to form a “source gather” or a “shot gather.” Another typical way of sorting of seismic data is called a “common midpoint (CMP) gather,” where traces are grouped based on the seismic waves having the same reflection point, estimated to be the central point between the source and receiver.

The surface seismic dataset is recorded and displayed as a function of two-way seismic travel-time (hereinafter, “two-way time”). Two-way time is the elapsed time between a firing of a seismic source (106) and the detection of a data sample. The two-way time of a surface seismic dataset may range from zero to eight seconds or more, depending on the depth of the subsurface discontinuity (112). The spatial extent of a surface seismic dataset may cover many tens of kilometers in two orthogonal directions. Consequently, a recorded reflected seismic wave (114), or “seismic reflection” may be detected in a surface seismic dataset over an area of hundreds of square kilometers.

A seismic dataset must be processed to produce valuable information, such as one or more seismic images or one or more seismic attributes. Typically, a seismic processing workflow includes a sequence of steps directed to noise attenuation, acquisition regularization, multiple identification and attenuation, seismic wave propagation velocity determination, seismic imaging, and seismic attribute determination. Several of these steps, such as seismic imaging and seismic attribute attenuation, require further interpretation to identify the locations within the subsurface at which hydrocarbon accumulations may be present. In some embodiments, the interpretation may occur after the generation of the post-stack seismic image or the seismic attribute. In other embodiments, the interpretation may be performed in parallel or interleaved or integrated into the process of determining the post-stack seismic image or the seismic attribute.

Seismic attributes generated or extracted from seismic datasets may include measurements based on polarity, phase, frequency, velocity, or time (or depth, when analyzing a depth-converted seismic dataset). Seismic attributes may be correlated with wellbore markers, which are depth indicators that may be superimposed on a seismic dataset or seismic image. Wellbore markers demarcate important geological zones within a wellbore and are often used in the interpretation of subsurface horizons as well as in the validation of depth-converted seismic datasets. For example, the depth, amplitude, and frequency content of a seismic reflection may be measured and correlated with wellbore markers.

Seismic attributes may include maximum, average, or root mean squared (RMS) amplitudes of seismic reflections. A seismic attribute may be measured at a single surface location or may be measured across a subterranean region to create a “seismic attribute volume.” Some examples of seismic attribute volumes include coherency volumes, dip or azimuth volumes, acoustic impedance volumes, curvature volumes, and seismic velocity volumes. In the present disclosure, a “set of seismic attributes” refers to the generation of one or more seismic attributes for a particular surface location. Similarly, a “set of seismic attribute volumes” refers to at least one seismic attribute volume covering a subterranean region. In general, a “seismic product” may include seismic datasets having undergone any amount of processing, seismic attributes, or seismic attribute volumes.

Dip volumes and azimuth volumes are generated from post-stack seismic data by comparing adjacent traces to compute best-fit planes representing the dip and azimuth of seismic reflections, respectively. Dip volumes represent the gradient magnitude (i.e., dip magnitude) of the best-fit planes, measured in degrees. Azimuth volumes represent the direction of maximum slope (i.e., dip direction) of the best-fit planes, measured in degrees clockwise from the North.

Seismic velocity volumes may be generated from surface seismic data through velocity analysis using techniques known to those skilled in the art such as full-waveform inversion, tomography, or interactive manual velocity analysis (“velocity picking”). Velocity analysis is the process of determining the velocity of seismic wave propagation in the subsurface, and may be estimated by finding the best-fit velocity function for seismic reflections exhibiting “moveout” within a CMP gather. Moveout is a phenomenon in which seismic reflections are detected on traces within a gather at increasing two-way travel times as the distance between source and receiver (“offset”) increases. Correcting for this travel-time difference is referred to as “moveout correction,” and a CMP gather with a velocity function applied is referred to as a “moveout-corrected” CMP gather. In some embodiments, seismic velocity may be estimated interactively by measuring the coherency of seismic reflections across traces within a moveout-corrected CMP gather. This may be done visually by a user, or by using a computer processor using techniques known to one ordinarily skilled in the art. Seismic velocity volumes may be used for stacking or migrating seismic data, or for converting seismic data from a two-way time domain to a depth domain (time-to-depth conversion). However, if the velocity of seismic wave propagation in the subsurface is uncertain, the conversion of the two-way time of a reflection to the corresponding depth of the subsurface discontinuity (112) that generated it will contain a related level of uncertainty.

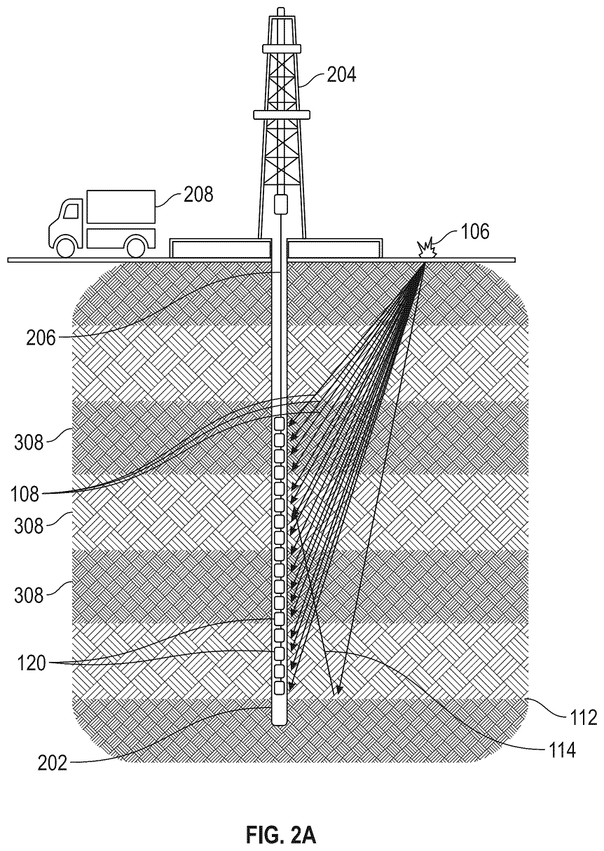

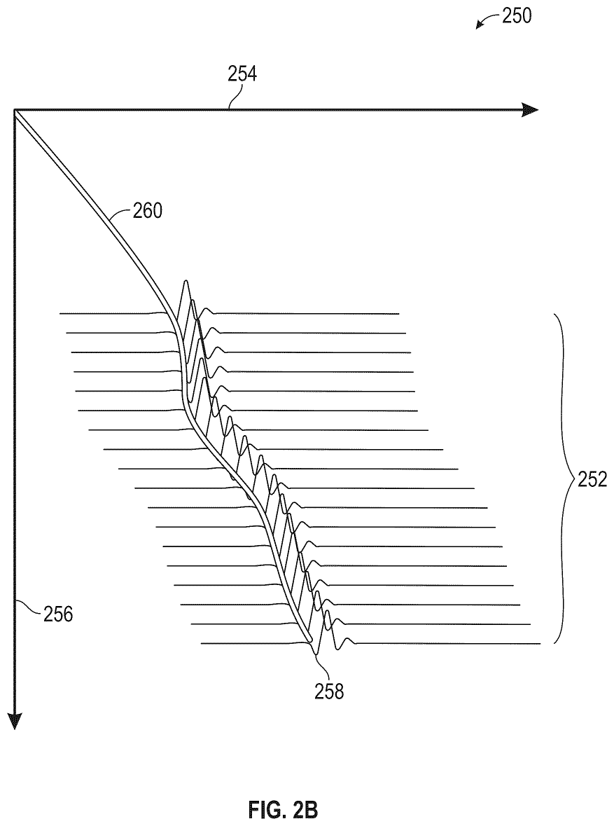

FIG. 2A depicts a borehole seismic survey in accordance with one or more embodiments. Unlike surface seismic datasets which are acquired using a plurality of seismic source and seismic receiver locations on the surface (116), a borehole seismic survey typically has at least one seismic source location on the surface (116) and a plurality of seismic receiver locations within a wellbore (202). The seismic receivers (120) may be suspended from a drill rig (204) or a crane (not shown) using a wireline cable (206). In addition to providing mechanical support to the seismic receivers (120) in the wellbore (202), the wireline cable (206) may provide electrical power to the seismic receivers (120) and transmit data recorded by the seismic receivers (120) to a recording facility (208) on the surface. In operations on land, the recording facility (208) may be mounted on a truck. The recording facility (208) may be part of a drilling rig or production platform or ship (not shown). When the seismic receivers (120) are deployed into the wellbore (202), the length of cable unspooled may be monitored, thus the depth of each of the seismic receivers (120) may be known at any time with a high level of certainty. In particular, the depth of each of the seismic receivers (120) may be known at the time at which a borehole seismic dataset is recorded with a high level of certainty.

When the seismic source (106) is excited, radiated seismic waves (108) may propagate from the seismic source (106) directly to the plurality seismic receiver locations, where they are recorded by seismic receivers (120). In addition, radiated seismic waves (108) may be reflected from geological discontinuities (112) and these reflected seismic waves (114) may be recorded by the seismic receivers (120). Borehole seismic datasets may be recorded by Vertical Seismic Profiles (VSPs) and/or by check-shot surveys. Typically, VSP surveys have a denser receiver sampling with depth than check-shot surveys. In check-shot surveys, seismic receiver positions may be widely and irregularly located in the well, whereas a VSP usually has numerous seismic receivers (120) positioned at closely and regularly spaced intervals in the well. In both check-shot surveys and VSPs, the seismic receivers (120) may record radiated seismic waves (108) from one or more excitations of the seismic source (106) and then be moved to a deeper or a shallower location in the wellbore (202) before recording data from subsequent excitations of the seismic source (106). Both VSPs and check-shot surveys may be used to determine the one-way seismic travel-time (“one-way time”) between the surface and the depth of each of the seismic receivers (120). However, while check-shot surveys are typically used to determine only one-way times, VSP are often also used to record reflected seismic waves (114) from geological discontinuities (112) and to form images thereof, in addition to determining one-way times.

FIG. 2B shows a borehole seismic dataset (250) in accordance with one or more embodiments. Borehole seismic datasets (250) may be used to determine the relationship between two-way time and depth at the well location. Specifically, check-shot survey data may generate a check-shot survey velocity profile. The variation of displacement with time, known as waveforms (252), represent radiated seismic waves (108) recorded by seismic receivers (120). The waveforms (252) are shown as a function of time, indicated on the horizontal axis (254), and seismic receiver depth, indicated on the vertical axis (256). The one-way time from the surface (116) to each seismic receiver (120) may be determined based on the first-break time (258) of the waveform (252). The first-break time (258) is the earliest arrival of propagated energy at a seismic receiver (120) and may be characterized as the first indication of seismic energy on a seismic trace. The curve of one-way time versus depth (260) is depicted in FIG. 2B. Multiplying the one-way time versus depth (256) by a factor of two yields an estimate of the two-way time versus depth curve (i.e., seismic velocity profile), at the well location.

Well logs, such as sonic well logs (or “sonic logs”) may be also used for estimating the seismic velocity profile at a well location. Sonic logs are recorded using a sonic tool, which may be suspended from a wireline cable that is then lowered into the wellbore (202). Typically, the sonic tool consists of at least one transmitter and at least one receiver. The transmitter emits sound waves which travel through the rock formation surrounding the borehole before being recorded by a receiver (120). The travel-time from source (i.e., transmitter) to receiver (120) is referred to as slowness, which is the reciprocal of velocity, and is usually expressed in units of microseconds/ft or microseconds/meter. The two-way time is derived from sonic logs by integrating the sonic log slowness values over the recorded depth values of the sonic log. In some embodiments, when both a sonic log and a borehole seismic dataset (250) are recorded in a wellbore (202), they may be combined to estimate the seismic velocity profile at the well location.

Seismic velocity profiles estimated from borehole data may be considered accurate measurements of seismic velocity at the well locations where they are acquired. It is desirable to extend these measured seismic velocity profiles to a 3D seismic velocity model which may be used for time-to-depth conversion of two-way time seismic datasets. Conventional interpolation methods used to build 3D seismic velocity models away from wellbores may not reliable, particularly when extrapolation is required. Further, many conventional methods are inefficient and require the computation of several 3D seismic velocity models in order to assess their accuracy.

Advanced geostatistical methods such as co-kriging may utilize an external variable to constrain the spatial interpolation, such as velocity models estimated from surface seismic datasets or another seismic attribute volume. However, these methods are limited to only one external variable and may not quantify associated uncertainties away from wellbores.

Machine learning may be used to predict seismic velocity models from borehole seismic data and seismic attribute volumes. In other words, seismic velocity profiles may be predicted for surface locations without borehole seismic data, using relationships between borehole seismic data and seismic attribute volumes. Furthermore, the associated uncertainties involved in depth-conversion may be properly estimated for any depth at any surface location within the 3D seismic velocity model.

Machine learning, broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein, however, one skilled in the art will recognize that the concepts and methods detailed hereafter are not limited by this choice of nomenclature.

Machine-learned model types may include, but are not limited to, neural networks, random forests, generalized linear models, Bayesian methods, and stochastic processes (e.g., Gaussian process regression). Machine-learned model types are usually associated with additional “hyper-parameters” which further describe the model. For example, hyper-parameters providing further detail about a neural network may include, but are not limited to, the number of layers in the neural network, choice of activation functions, inclusion of batch normalization layers, and regularization strength. The selection of hyper-parameters surrounding a model is referred to as selecting the model “architecture.” Generally, multiple model types and associated hyper-parameters are tested and the model type and hyper-parameters that yield the greatest predictive performance on a validation set of data is selected.

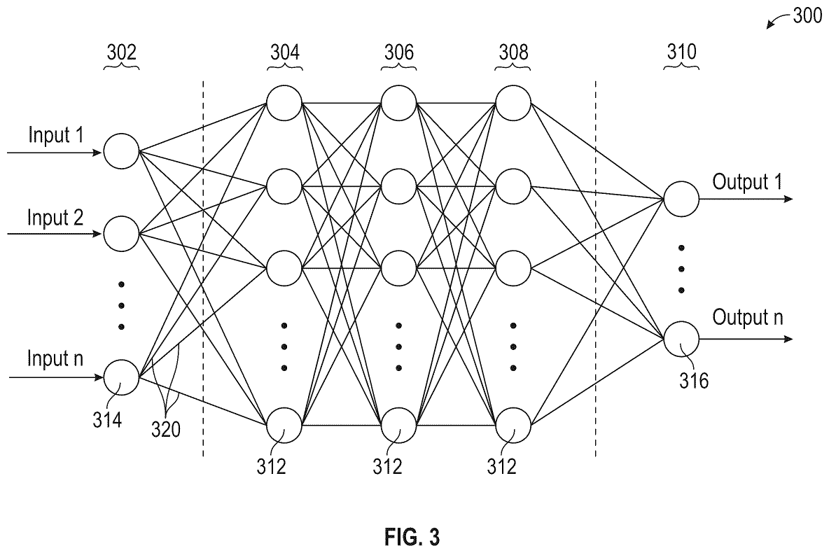

FIG. 3 illustrates an artificial neural network in accordance with one or more embodiments. A neural network (300) uses a series of mathematical functions to make predictions based on observations. A neural network (300) may include an input layer (302), hidden layers, such as a first hidden layer (304), a second hidden layer (306), a third hidden layer (308), and an output layer (310). Each layer represents a vector where each element within each vector is represented by an artificial neuron (312) (hereinafter also “neuron”). A neuron (312) is loosely based on a biological neuron of the human brain. The input layer (302) may receive an “observed” data vector x where each neuron, such as neuron (314), within the input layer (302) receives one element xᵢ within x. Each element is a value that represents a datum that is observed. The vector x may be called “input data” and, in some embodiments, may include a seismic attribute volume. FIG. 3 displays the input data or vector x as elements x₁, x₂, . . . xₙ, where x₁ may be a value that represents a seismic trace of a first spatial position, x₂ may be a value that represents a measure of dip for a seismic reflection at a second spatial position, etc.

The output layer (310) may represent the vector y where each neuron, such as neuron (316) within the output layer (310), represents each element yⱼ within y. The vector y may be called “output data” and, in some embodiments, may be a seismic velocity model. FIG. 3 displays the output data or vector y with m elements, where an element yⱼ may be a value that represents a seismic velocity value at a temporal and spatial location within a subterranean region. In some embodiments, the neural network (300) may solve a regression problem where all outputs yₘ may depend on a temporal or spatial position.

Neurons in the input layer (302) may be connected to neurons in the first hidden layer (304) through connections (320). A connection (320) is analogous to a synapse of the human brain, and may have a weight associated to it. The weights for all connections (320) between the input layer (302) and the first hidden layer (304) make up a first array of weights w, with elements wᵢₖ:

$$\\ \begin{matrix}w = [ \begin{matrix}{w}_{11} & {w}_{12} & {w}_{1 k} & {w}_{1 L} \\ {w}_{21} & {w}_{22} & {w}_{2 k} & {w}_{2 L} \\ {w}_{i 1} & {w}_{i 2} & {w}_{ik} & {w}_{iL} \\ {w}_{n 1} & {w}_{n 2} & {w}_{nk} & {w}_{nL}\end{matrix} ] , & Equation ( 1 )\end{matrix}$$

where k indicates a neuron in the hidden first hidden layer and L is the total number of neurons in the first hidden layer for the embodiment shown in FIG. 3. The elements in each column are the weights associated with the connections (320) between each of the n elements in vector x that propagate to the same neuron k in the first hidden layer (304). The value of a neuron k, aₖ, in the first hidden layer may be computed as

aₖ=gₖ(bₖ+Σᵢxᵢwᵢₖ), Equation (2)

where, in addition to the elements of the input vector x and the first array of weights w, elements from a vector b, which has a length of L, and an activation function gₖ, are referenced. The vector b represents a bias vector and its elements may be referred to as biases. In some implementations, the biases may be incorporated into the first array of weights such that Equation (2) may be written as a k=gₖ(Σᵢxᵢwᵢₖ).

Each weight wᵢₖ within the first array of weights may amplify or reduce the significance of each element within vector x. Some activation functions may include the linear function g(x)=x, sigmoid function

$$\\ g ( x ) = \frac{1}{1 + {e}^{- x}} ,$$

and rectified linear unit function g(x)=max(0, x); however, many additional functions are commonly employed. Every neuron (312) in a neural network (300) may have a different associated activation function. An activation function may be considered as a threshold function that determines whether a neuron (312) is activated or not. An activated neuron (312) transmits data, through the connections (320), to the next layer. Often, as a shorthand, activation functions are described by the function gₖ by which it is composed. An activation function composed of a linear function may simply be referred to as a linear activation function without undue ambiguity.

Similarly, the weights for all connections (320) between the first hidden layer (304) and the second hidden layer (306) make up a second array of weights. The second array of weights will have L rows, one for each neuron in the first hidden layer, and a number of columns equal to the number of neurons in the second hidden layer. Likewise, a second bias vector and second activation functions may be defined to relate the first hidden layer (304) to the second hidden layer (306). The values of the neurons for the second hidden layer (306) are likewise determined using Equation (2) as before, but with the second array of weights, second bias vector, and second activation functions. This process of determining the values for a hidden layer based on the values of the neurons of the previous layer and associated array of weights, bias vector, and activation functions is repeated for all layers in the neural network (300). As stated above, the number of layers in a neural network is a hyperparameter of the neural network (300). It is noted that FIG. 3 depicts a simple and general neural network (300). In some embodiments, the neural network (300) may contain specialized layers, such as a normalization layer, or additional connection procedures, like concatenation. One skilled in the art will appreciate that these alterations do not exceed the scope of this disclosure.

For a neural network (300) to complete a “task” of predicting an output from an input, the neural network (300) must first be trained. Training may be defined as the process of determining the values of all the weights and biases for each weight array and bias vector encompassed by the neural network (300).

To begin training, the weights and biases are assigned initial values. These values may be assigned randomly, assigned according to a prescribed distribution, assigned manually, or by some other assignment mechanism. Once the weights and biases have been initialized, the neural network (300) may act as a function, such that it may receive inputs and produce an output. As such, at least one input is propagated through the neural network (300) to produce an output. A training dataset is composed of inputs and associated target(s), where the target(s) represent the “ground truth,” or otherwise desired output. That is, the training dataset may be a plurality of input data and a plurality of target data, either of which may be observed or simulated. The neural network (300) output, or “predicted output”, is compared to the associated input data target(s). The comparison of the predicted output to the target(s) is typically performed by a so-called “loss function;” although other names for this comparison function such as “error function,” “objective function,” “misfit function,” and “cost function” are commonly employed. Many types of loss functions are available, such as the mean-squared-error function; however, the general characteristic of a loss function is that the loss function provides a numerical evaluation of the similarity between the predicted output and the associated target(s). The loss function may also be constructed to impose additional constraints on the values assumed by the weights and biases, for example, by adding a penalty term, which may be physics-based, or a regularization term. Generally, the goal of a training procedure is to alter the weights and biases to promote similarity between the predicted output and associated target(s) over the training dataset. Thus, the loss function is used to guide changes made to the weights and biases, typically through a process called “backpropagation.”

Backpropagation consists of computing the gradient of the loss function over the weights and biases. The gradient indicates the direction of change in the weights and biases that results in the greatest change to the loss function. Because the gradient is local to the current weights and biases, the weights and biases are typically updated by a “step” in the direction indicated by the gradient. The step size is often referred to as the “learning rate” and need not remain fixed during the training process. Additionally, the step size and direction may be informed by previously seen weights and biases or previously computed gradients. Such methods for determining the step direction are usually referred to as “momentum” based methods.

Once the weights and biases have been updated or altered from their initial values through a backpropagation step, the neural network (300) will likely produce different outputs. Thus, the procedure of propagating at least one input through the neural network (300), comparing the predicted output with the associated target(s) with a loss function, computing the gradient of the loss function with respect to the weights and biases, and updating the weights and biases with a step guided by the gradient, is repeated until a termination criterion is reached. Common termination criteria are: reaching a fixed number of updates, otherwise known as an iteration counter; a diminishing learning rate; noting no appreciable change in the loss function between iterations; and, reaching a specified performance metric as evaluated on the data or a separate hold-out dataset. Once the termination criterion is satisfied and the weights and biases are no longer intended to be altered, the neural network (300) is said to be “trained”.

Following training, the neural network (300) may perform a task to predict unknown output data from input data without associated known target(s). If additional input data and associated target(s) become available that augment the training dataset, the neural network (300) may be re-trained. Re-training may encompass re-initializing the weights and biases and repeating the backpropagation process using the augmented training dataset. Alternatively, re-training may use a transfer learning approach where a subset of the weights and biases are fixed, and the remaining weights and biases are updated using the augmented training dataset.

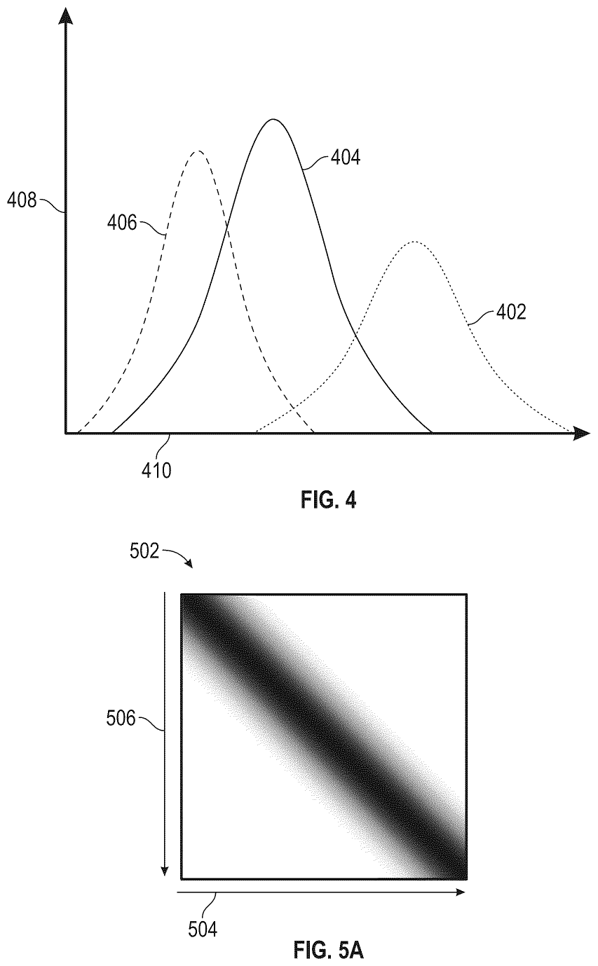

FIG. 4 shows examples of probability distributions in accordance with one or more embodiments. Processes such as forward modeling, inversion, and machine learning may be performed within the theoretical framework of Bayesian statistics, which is based on Bayes' theorem. In the context of this disclosure, Bayesian statistics defines a velocity value (within a seismic velocity model) as a degree of belief, where Bayes' theorem quantifies the degree of belief using a probability distribution (PD). The PD may be continuous-valued, discrete-valued, or a combination of discrete and continuous. In accordance with one or more embodiments, the PD may be represented as a probability mass function (PMF) or a probability density function (PDF). Hereinafter, “degree of belief” and “PD” will be considered synonymous and used interchangeably. Bayes' theorem may be used to update a previous degree of belief as more evidence or data becomes available.

By way of example, FIG. 4 depicts three probability distributions to describe Bayes' theorem pictorially. Three distributions (402, 404, 406) are plotted with the vertical axis (408) representing the density of probability, or the chance of obtaining values at corresponding points on the horizontal axis (410). The previous degree of belief is referred to as a “prior” (402) denoted P(A). The prior P(A) (402) may be based on a prior assumption A (or a previous “posterior”). A posterior (404), denoted P(A|B), is the degree of belief of A taking new evidence B into account. Bayes' theorem updates a prior P(A) (402) to a posterior P(A|B) (404) based on the new evidence B such that:

$$\\ \begin{matrix}P ( A \vert B ) = \frac{P ( B \vert A ) \cdot P ( A )}{P ( B )} , & Equation ( 3 )\end{matrix}$$

where P(B) is the degree of belief of the new evidence B (or marginal), and P (B|A) is a likelihood function (406). The likelihood function P(B|A) (406) is a probability of B given A. In other words, the likelihood function P(B|A) (406) describes how likely the new evidence B is assuming A is true. The likelihood function shifts the degree of belief of A closer to the true or actual degree of belief of A. The law of total probability may be used to calculate P(B); however, in cases where P(B) is difficult to calculate, P(B) may be omitted, such that:

P(A|B)∝P(B|A)·P(A). Equation (4)

Bayes' theorem may be used to update a PD of a velocity value within a seismic velocity model to shift the degree of belief of the velocity value closer to the true degree of belief, iteratively. New evidence B is available for each iteration and the posterior P(A|B) (404) of the previous iteration k−1 becomes the prior P (A) (402) for the current iteration k such that:

P(Aₖ|Bₖ)∝P(Bₖ|Aₖ)·P(Aₖ₋₁|Bₖ₋₁). Equation (5)

This idea is known as Bayesian inference. Specifically, Bayesian inference is a method of statistical inference in which Bayes' theorem is used to update assumption A.

While Bayesian inference may be directly applied to update the PD of a velocity value, probability distribution sampling methods may also be implemented. One reason to implement probability distribution sampling methods is to reduce computational cost. A stochastic process, which may be considered a machine-learned model, is a collection of random variables (RVs) indexed by a mathematical set, where each RV is uniquely associated with an element in the set. In general, an RV is a mathematical object, which may comprise a function, or a rule set which maps an event to a numeric value. Different events and their associated numeric values may be observed with different frequencies. As such, an RV often further comprises a PD representing the relative probabilities of observing an event. A stochastic process may be further defined depending on the properties and inter-relationships between the RVs. For example, if a finite collection of RVs may be jointly represented as a multi-variate Gaussian, the stochastic process is called a Gaussian process.

Each random variable in a stochastic process is associated with a spatial location, temporal location, or both a spatial and temporal location. As such, a stochastic process may be considered a collection of PDs, where each PD has a known location in space, time, or both space and time. For example, consider a 1-dimensional spatial system with an “x-axis”; that is, a spatial location is specified with an x-value. Without loss of generality, x₁, x₂, x₃, . . . , xₙ may represent various locations along the x-axis. A stochastic process may define an RV (and associated PD), at each location x₁, x₂, x₃, . . . , xₙ. The RVs encompassed by a stochastic process may be covariant.

One with ordinary skill in the art will appreciate that there are various ways to interpret and understand a stochastic process. One perspective is to consider a stochastic process as defining a PD over a space of functions (a “function space”). Like the Bayesian framework previously described, a stochastic process possesses the concept of a prior. The prior of a stochastic process defines a PD over the function space before observing any data. Once data has been observed (e.g., training data), a stochastic process is “conditioned” such that the PD over function space is congruent with the observed data. This conditioned PD over function space could be considered a posterior, and because the posterior of a stochastic process is a PD over a function space, sampling the PD returns a function. Functions sampled from the posterior of a stochastic process will satisfy any constraints imposed by the observed data. In order to specify a PD over the function space, additional information must be provided to a stochastic process.

For a Gaussian process (GP), the PD over function space may be defined with a “mean function” and a “kernel.” The mean function specifies the mean value of each RV in the collection encompassed by the GP. Recall, that each RV in a stochastic process, such as a GP, has an associated location—spatial, temporal, or both. As such, the mean function indicates the “expected” value at that location. Here, “expected” refers the expectation operator, where for a given continuous random variable X over a domain x with a probability density function p(x), the expectation is E[X]=∫_{-∞}^{+∞}xp(x).

The kernel of a GP indicates inter-relationships (i.e., covariances), if any, between the RVs of the GP, as well as their strength. GP kernels may be described by kernel functions; that is, a kernel function may accept any pair of RVs within the collection of the GP and return their covariance. As is often done in the literature, kernel functions may simply be referred to as “kernels” without undue ambiguity. Common GP kernels include but are not limited to: white noise kernel; exponentiated quadratic kernel (also known as the squared exponential kernel, Gaussian kernel, or radial basis functions); rational quadratic kernel; and the periodic kernel. One with ordinary skill in the art will recognize that GP kernels may be formed specific to the context of the application, or GP kernels may be constructed from pre-defined kernels according to valid mathematical operations, such that those enumerated herein do not impose a limitation on the present disclosure. When a kernel function is used to determine covariances of a finite collection of RVs, the kernel may be considered a matrix, and in order to be a valid GP kernel, the kernel matrix must be positive definite.

GP kernels often include hyper-parameters, such as “variance” or “length scale.” Additional hyper-parameters may be associated with a GP. The combination of a selected GP kernel, a mean function, and any associated hyper-parameters define the PD over the function space and define a “GP model.” As such, the GP model indicates the behavior of functions that may be sampled from the function space. For example, when using a periodic kernel, only periodic functions are sampled from the function space. Further, the hyper-parameters of a periodic kernel may specify the expected period length, or frequency of any sampled function.

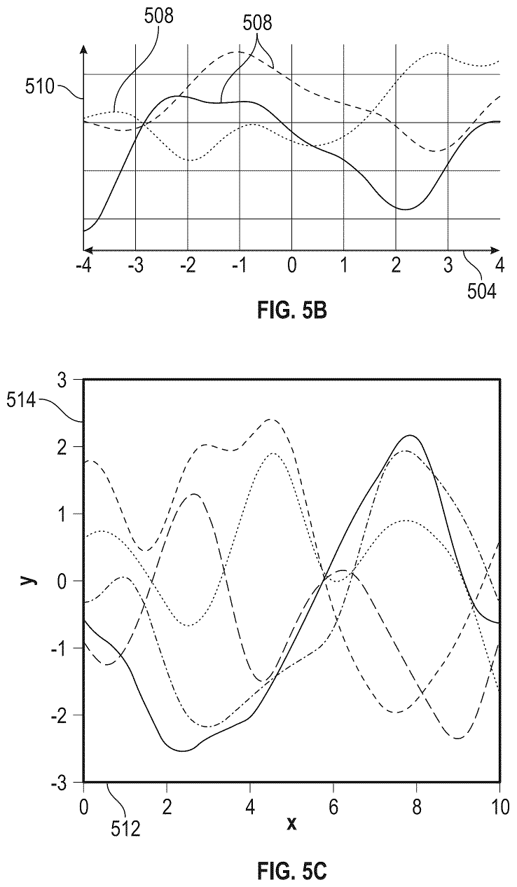

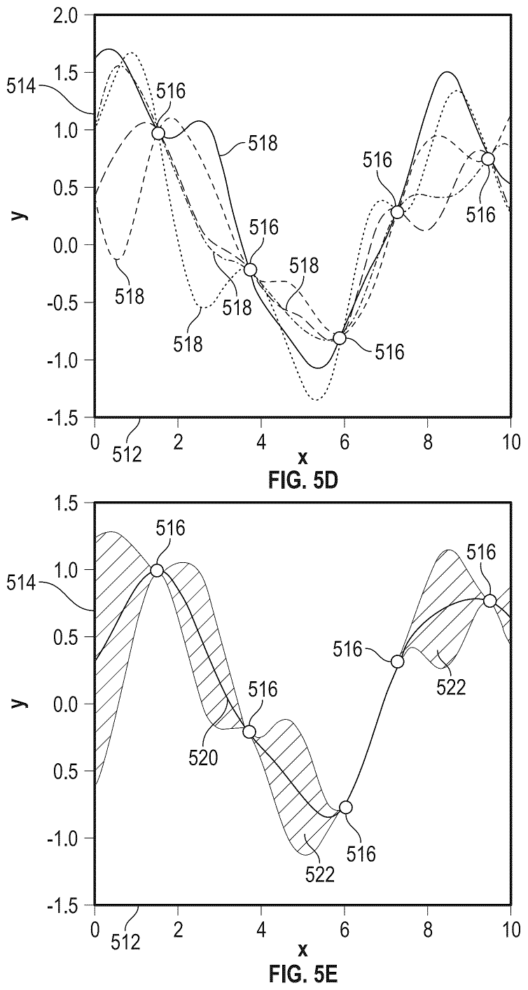

FIG. 5A shows an example of a kernel matrix and FIG. 5B shows associated sampled functions from the function space, wherein the mean function is zero for all values. More specifically, FIG. 5A shows a squared exponential kernel matrix (502). The squared exponential kernel matrix (502) indicates the covariance between RVs of the GP according to their spatial location. That is, the covariance between RVs is a function of their spatial proximity, and the covariance between RVs decreases with increasing spatial distance between RVs. In FIG. 5A, darker shading indicates a higher covariance, whereas lighter shading indicates a lower covariance. The kernel and mean function are defined for a single spatial variable x over a domain of [−4, 4]. That is, the horizontal axis (504) and vertical axis (506) both denote values of x and thus both axes range from −4 to 4. Sampled functions from the associated PD of the GP will be a univariate function of the form y=f(x), where the domain of x is valid over the interval [−4, 4]. Typically, the sampled functions (508) are continuous and smooth-varying. FIG. 5B shows three sampled functions (508) from the function space according to the associated PD over this space. The horizontal axis (504) denoting values of x, and the vertical axis (510) denoting values of y. As the squared exponential kernel indicates greater covariance according to proximity, approximate spatial locations of x have similar values of y.

FIGS. 5C-5E show an example application of a Gaussian process called Gaussian process regression. This example considers a single spatial variable x over the domain [0, 10], represented by the horizontal axes (512), and any functions sampled from the GP will be univariate with the form y=f(x), represented by the vertical axes (514). For brevity, the mean function, kernel, and hyper-parameters of this GP are not discussed in detail. However, the mean function is the zero function, f(x)=0, and the kernel is the squared exponential kernel. With a mean function and kernel defined, functions may be sampled from the GP.

FIG. 5C shows a prior in accordance with one or more embodiments. In other words, FIG. 5C shows a set of functions sampled from the function space for which no data has been observed. The PD of the GP may be considered a prior PD and the sampled functions may be considered “prior functions.” Once data is observed, the PD over the function space may be conditioned on the observed data (e.g., training data, and the resulting conditioned PD may be considered a posterior PD.

FIG. 5D shows a posterior in accordance with one or more embodiments. The observed data (516) are composed of five x-y pairs, plotted in FIG. 5D. Conditioning the PD on the observed data (516) may be computationally intense and/or may include the use of mathematical properties of the Gaussian process. A detailed description is not provided here for brevity; however, one of ordinary skill in the art will recognize that this omission is non-limiting for the present disclosure. The posterior PD may be sampled to obtain “posterior functions” (518) which are congruent with the observed data (516). As seen in FIG. 5D, the posterior functions (518) sampled from the posterior PD all demonstrate agreement with the observed data (516). The posterior functions (518) may be used to make predictions outside of the observed data (516).

An important property of a Gaussian PD is that if two sets of variables are jointly Gaussian, the conditional PD of one set conditioned on the other set is again Gaussian. Additionally, the mean and variance of any individual RV in a GP may be extracted; therefore, the posterior PD of the GP may be used to determine the mean and covariance of all associated RVs. In the present example, the RVs are associated with a spatial location, and form a probabilistic function.

FIG. 5E shows a probabilistic function in accordance with one or more embodiments. It may be noted that the probabilistic function agrees with the observed data (516) and represents the mean prediction (520) or expected value. The covariance between the output RVs is represented by the uncertainty function (522) and is reduced close to observed data (516) points. The uncertainty associated with a mean prediction (520) may be expressed as a “confidence interval,” which is the mean prediction (520) bounded by the variance. A confidence interval may give an indication of the degree of uncertainty of the prediction and (probabilistically) excludes values outside of the interval. In other words, data (or predictions) within a smaller confidence interval may indicate a higher degree of compatibility with the observed data (516). Uncertainty, when represented using confidence intervals, may be expressed as a percentage. For example, for a given predicted value, a 95% confidence interval implies there is a 95% probability that the true value lies between the boundaries defining the confidence interval.

The example shown by FIGS. 5C-5E demonstrates a Gaussian process for a single spatial variable; however, stochastic processes (and therefore Gaussian processes), may be extended to higher dimensions and which may include both temporal and spatial dimensions.

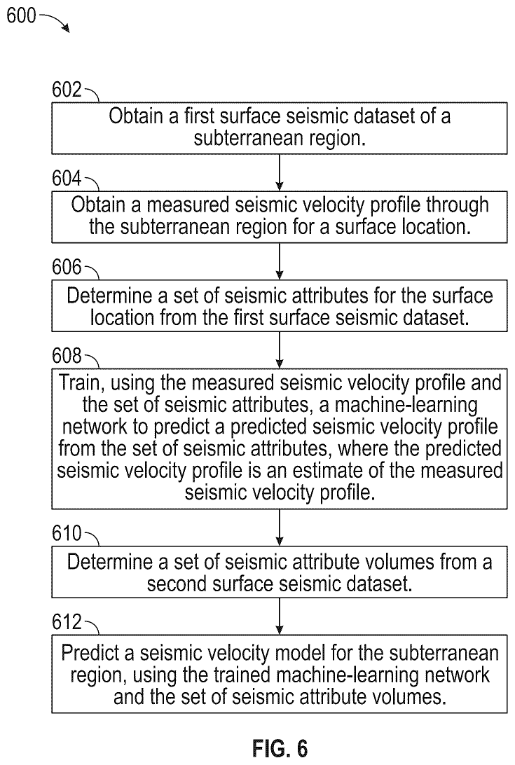

FIG. 6 shows a flowchart (600) in accordance with one or more embodiments. In Step 602 of the flowchart (600), a first surface seismic dataset for a subterranean region is obtained. The first surface seismic dataset may be acquired using a seismic survey (100) including a seismic source (106) and a plurality of seismic receivers (120). In some embodiments the first surface seismic dataset may include a plurality of pre-stack traces. In other embodiments the first surface seismic dataset may be a post-stack volume.

In Step 604, a measured seismic velocity profile through the subterranean region for a surface location is obtained. The measured seismic velocity profile may be calculated from a borehole seismic dataset (250) or a sonic log recorded from a wellbore (202) at the surface location. In some embodiments, the measured seismic velocity profile may be a check-shot survey velocity profile. In other embodiments, the borehole seismic data may be recorded by a VSP. The measured seismic velocity profile may include depth and two-way time data pairs.

In Step 606, a set of seismic attributes for the surface location is determined from the first surface seismic dataset. In some embodiments, the first surface seismic dataset may be processed or interpreted before seismic attributes are generated. The set of seismic attributes may include spatial coordinates, or migration or stacking seismic velocity profiles. The seismic velocity profiles may be generated from the first surface seismic dataset using velocity analysis techniques known to one ordinarily skilled in the art. The set of seismic attributes may further include dip or azimuth measurements for a seismic reflection at a surface location, which may be extracted from a dip volume or azimuth volume, respectively. In other embodiments, a seismic horizon passing through the surface location may be interpreted from the first surface seismic dataset. The set of seismic attributes may further include the time and depth relationship of the seismic horizon and a corresponding wellbore marker for a wellbore (202) at the surface location.

In Step 608, a machine-learning network is trained, using the measured seismic velocity profile and the set of seismic attributes, to predict a predicted seismic velocity profile from the set of seismic attributes, where the predicted seismic velocity profile is an estimate of the measured seismic velocity profile. The machine-learning network may include Gaussian process regression and may be trained using a training dataset. The training dataset may include the measured seismic velocity profile obtained in Step 604, or the set of seismic attributes determined in Step 606. The training dataset may include all surface locations having both seismic velocity profile information and seismic attribute information and may undergo a quality control process. In other embodiments, the training dataset may be divided into three independent datasets: a training dataset, a validation dataset, and a test dataset. The training wells may be used for training the network, the validation wells may be used to optimize hyper-parameters, and the testing set may be used to verify that the network can predict seismic velocity profiles for surface locations where a borehole seismic dataset has not been recorded. Hyper-parameters may be optimized in order to minimize a loss function describing the difference between the measured seismic velocity profile (i.e., the target) and the predicted velocity profile. Optimization of hyper-parameters may include optimizing the basis function, the kernel (covariance) function, defining an initial value for the noise standard deviation, or controlling the normalization of the observed data.

In Step 610, a set of seismic attribute volumes is determined from a second surface seismic dataset. In some embodiments, the second surface seismic dataset may be processed before seismic attribute volumes are generated. The set of seismic attribute volumes may include spatial and temporal coordinates, a dip volume, an azimuth volume, or seismic velocity volumes. The seismic velocity volumes may be estimated from the second surface seismic dataset using velocity analysis techniques known to those ordinarily skilled in the art. In other embodiments, the second surface seismic dataset may be the same as the first surface seismic dataset.

In Step 612, a seismic velocity model for the subterranean region is predicted using the trained machine-learning network and the set of seismic attribute volumes. Seismic velocity values may be predicted for any point in 3D space of the subterranean region, resulting in a seismic velocity model. The seismic velocity model may include an uncertainty estimate provided by the posterior covariance matrix. In some embodiments, the predicted velocity values may correspond to average (RMS) velocities required for the time-to-depth-conversion of two-way time seismic products such as seismic datasets, horizons, or fault plane networks. The depth-converted, or depth-domain seismic products may be correlated with well data, production data, geological targets, or other information that requires depth-domain seismic products.

In other embodiments, an RMS velocity model may be converted to an interval velocity model using Dix conversion or any other method known to one ordinarily skilled in the art. The interval velocity model may be updated and used to generate a migrated depth-domain seismic image. The uncertainty estimate associated with the seismic velocity model used for time-to-depth conversion may be represented as a confidence interval for a given depth in the depth-domain seismic image. The confidence interval may indicate the reliability of the depth-domain seismic image at a particular location. The depth-domain seismic image may be used to determine geological properties or for seismic attribute analysis.

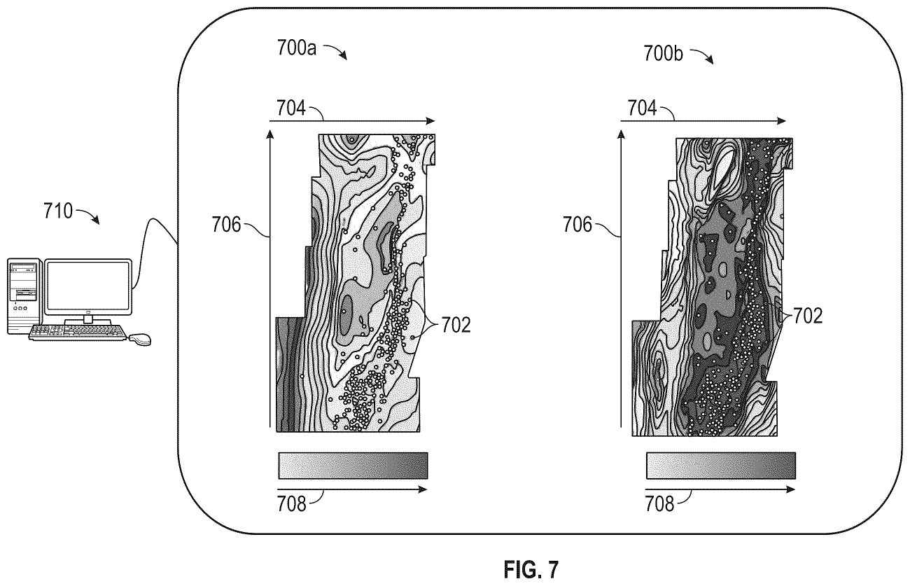

FIG. 7 depicts a seismic interpretation workstation displaying a mean of predicted velocities (700a) and a standard deviation of predicted velocities (700b) in accordance with one or more embodiments. Making probabilistic velocity predictions using Gaussian process regression may require evaluating a conditional probability P(y_{new}|y, X, x_{new}), where y_{new} is the output vector (e.g., predicted velocities), x_{new} is an input vector, and X and y are the observed data (e.g., training data). Using the definition of conditional probability for RVs, the conditional density may be written as:

$$\\ \begin{matrix}P ( {y}_{new} \vert y , X , {x}_{new} ) = \frac{P ( {y}_{new} , y \vert X , {x}_{new} )}{P ( y \vert X , {x}_{new} )} . & Equation ( 6 )\end{matrix}$$

In some embodiments, the GP regression model used to predict velocities may be represented as h(x)^{T}β+f(x), where f(x)˜GP(0, k(x, x′)). That is, f(x) are from a zero mean GP with covariance kernel functions k(x, x′). h(x) are basis functions with coefficients β. Variance σ² and basis coefficients β are hyper-parameters estimated from the observed data. With the GP regression model defined, the conditional probability in Equation (6) may be written as a conditional distribution:

P(y_{new}|y,X,x_{new})˜ [symbol] (y_{new}|h(x_{new})^{T}β+μ,σ_{new}²+Σ), Equation (7)=

where

μ=K(x_{new}^{T},X)(K(X,X)+σ²Iₙ)⁻¹(y−Hβ)) Equation (8)

and

Σ=k(x_{new},x_{new})−K(x_{new}^{T},X)(K(X,X)+σ²Iₙ)⁻¹K(X,x_{new}^{T}) Equation (9)

In Equations (8) and (9), H denotes the basis function matrix, and K(X,X) denotes the kernel covariance matrix.

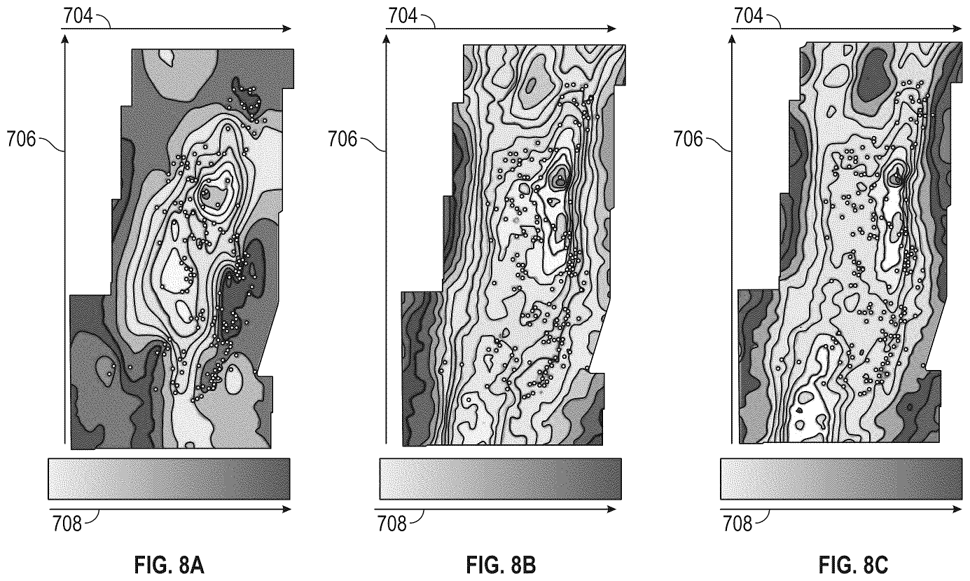

In FIG. 7, the map of mean predicted velocities (700a) shown are extracted from a predicted 3D velocity model along a seismic horizon. The velocity model covers a subterranean region that includes wellbore surface locations (702). Further, the velocity model shown is gridded using a seismic grid. A seismic grid is used to organize seismic data and relates spatial coordinates to “inline” and “crossline” values. This relation may be dependent on seismic acquisition parameters such as source and receiver locations. In FIGS. 7-8C, the horizontal axis (704) represents crossline values, and the vertical axis (706) represents inline values. The color scale (708) indicates lower values are represented by lighter shading, while higher values are represented by darker shading.

Once the velocity model for a subterranean region is predicted, a seismic product in the two-way time (TWT) domain may be converted to the depth domain using the following equation:

$$\\ \begin{matrix}Z = {V}_{avg} \cdot ( \frac{TWT}{2} ) , & Equation ( 10 )\end{matrix}$$

where Z is the depth, V_{avg} is the mean predicted velocity, and TWT is the two-way time.

FIG. 7 also shows the standard deviation of the mean predicted velocities (700b). The standard deviation (or variance) of the posterior PD indicates the uncertainty in the predictions, which is lower where wellbore surface locations (702) are clustered, or spatially proximate. That is, the uncertainty is zero at spatial locations where the posterior is congruent with the observed data (e.g., training data).

The horizon attribute maps shown in FIGS. 7-8C may be generated and visualized using a seismic interpretation workstation (710). The process of determining geological properties from a seismic image or seismic attribute image is called seismic interpretation. For example, identifying a discontinuity in an otherwise continuous surface of high amplitude seismic reflections as a geological fault, or identifying a region with anomalously high seismic wave attenuation as indicative of a hydrocarbon gas deposit, are seismic interpretations. Additional seismic attributes such as coherence cubes, that measure the similarity of adjacent portions of the seismic image, may be generated during seismic interpretation.

Seismic interpretation may include manual steps, such as “picking” a sparse set of points on a single interpreted undulating geological boundary (e.g., a seismic horizon), and automatic or algorithmic steps, such as picking all the remaining grid points lying on the boundary using the manually picked points as a guide or “seeds”. Once a seismic horizon is defined, attributes may be generated along the seismic horizon and may be visualized in the form of an attribute map.

The output of seismic interpretation often includes the seismic image or attribute image, with the interpretation of labelled geological boundaries, faults, wellbore markers, pore fluid contact levels, gas deposits etc., drawn and annotated on the image. In the past, such interpretation was performed using displays of portions of the seismic image printed on paper with the interpretation drawn, originally hand-drawn, on the paper using colored pen or pencils. Now, a seismic interpreter of ordinary skill in the art will, almost without exception, use a seismic interpretation workstation (710) to perform seismic interpretation.

A seismic interpretation workstation (710) may include one or more computer processors and a computer-readable medium (memory) containing instructions executable by the processor. The computer memory may further contain seismic images and/or seismic attributes. The seismic interpretation workstation may also include a display mechanism, usually one or more monitor screens, but sometimes one or more projector, user-wearable goggles or other virtual reality display equipment and a means of interacting with the display, such as a computer mouse or wand. Further, the seismic interpretation workstation may include a robust graphics card or other dedicated hardware designed to expedite the rendering and display of the seismic image, images, or attributes in a manner and at a speed to facilitate real-time interaction between the user and the data. For example, the seismic interpretation workstation may allow the seismic interpreter to scroll through adjacent slices through a 3D seismic image to visually track the continuity of a candidate geological boundary throughout the 3D image. Alternatively, the seismic interpretation workstation may allow the seismic interpreter to manually control the rotation of the view angle of the seismic image so it may be viewed from above, or from the East or from the West, or from intermediate directions.

As for the seismic interpretation system, the computer processor or processors and computer memory of the seismic interpretation workstation may be co-located with the seismic interpreter, while in other cases the computer processor and memory may be remotely located from the seismic interpreter, such as on “the cloud.” In the latter case, the seismic or attribute images may only be displayed on a screen, including a laptop or tablet local to the seismic interpreter, who may interact with the computer processor via instructions sent over a network, including a secure network such as a virtual private network (VPN).

FIGS. 8A-C show expected values in accordance with one or more embodiments. If the predicted velocity and TWT in Equation (10) are assumed to be statistically independent, the expectation of their product (depth, Z) is the product of their expectations, such that:

$$\\ \begin{matrix}E ( Z ) = E ( {V}_{avg} \cdot ( \frac{TWT}{2} ) ) = \frac{1}{2} E ( {V}_{avg} ) \cdot E ( TWT ) . & Equation ( 11 )\end{matrix}$$

The expectations of the mean predicted velocities for the seismic horizon is shown in FIG. 8A. Similarly, expectations of TWT for the seismic horizon is shown in FIG. 8B. FIG. 8C shows the expectation of the depth, which is computed from the product of the expectation of the mean predicted velocity and the expected TWT along the seismic horizon.

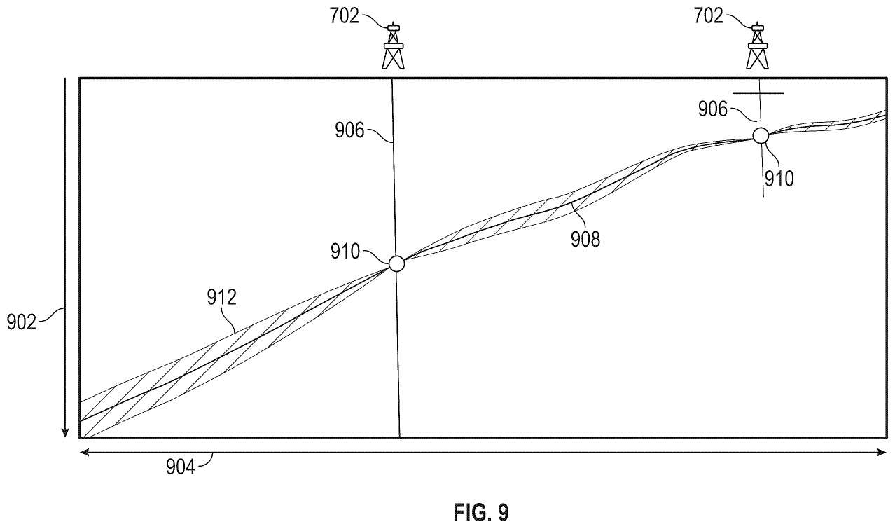

FIG. 9 shows a plot of expected depth with associated uncertainties in accordance with one or more embodiments. The associated uncertainties may be expressed in terms of variance, standard deviation, or any selected confidence interval (e.g., 90%, 95%). Analogous to the derivation of Equation (11), the variance of the depth, σ_{Z}², may be inferred using the following equations:

$$\\ \begin{matrix}Var ( Z ) = {σ}_{Z}^{2} = Var ( {V}_{avg} \cdot ( \frac{TXT}{2} ) ) , & Equation ( 12 )\end{matrix}$$

$$\\ or ,$$

$$\\ \begin{matrix}{σ}_{Z}^{2} = \frac{1}{2} [ ( {σ}_{{V}_{avg}}^{2} + {μ}_{{V}_{avg}}^{2} ) ( {σ}_{TWT}^{2} + {μ}_{TWT}^{2} ) - {μ}_{{V}_{avg}}^{2} {μ}_{TWT}^{2} ] , & Equation ( 13 )\end{matrix}$$

where μ_{V}_{_{avg}}² and μ_{TWT}² are the means, and σ_{V}_{_{avg}}² and σ_{TWT}² are the variances of the independent variables V_{avg} and TWT, respectively.

The cross-section of the subterranean region shown in FIG. 9 displays increasing depth along the vertical axis (902), and distance from a given spatial position along the horizontal axis (904). Wellbore surface locations (702) are shown with their respective wellbore paths (906) penetrating the subterranean region to different depths. The expectation of depth (908) of a seismic horizon is shown between two wellbore surface locations (702). The wellbore markers (910) indicate known depth and TWT pairs of the horizon, included in the observed data. The depth expectation (908) of the horizon intersects these wellbore markers (910), which shows the mean predicted velocities honor the observed data. Further, shaded areas indicate the uncertainty associated with the depth expectation (908) via a 90% confidence interval (912). It is noted that the confidence interval (912) is larger between wellbore surface locations (702) and is zero at the wellbore markers (910), indicating the predicted velocities are compatible with the observed data. Uncertainty estimates associated with the depths of geological features may be used to measure risk associated with locating and drilling into hydrocarbon reservoirs.

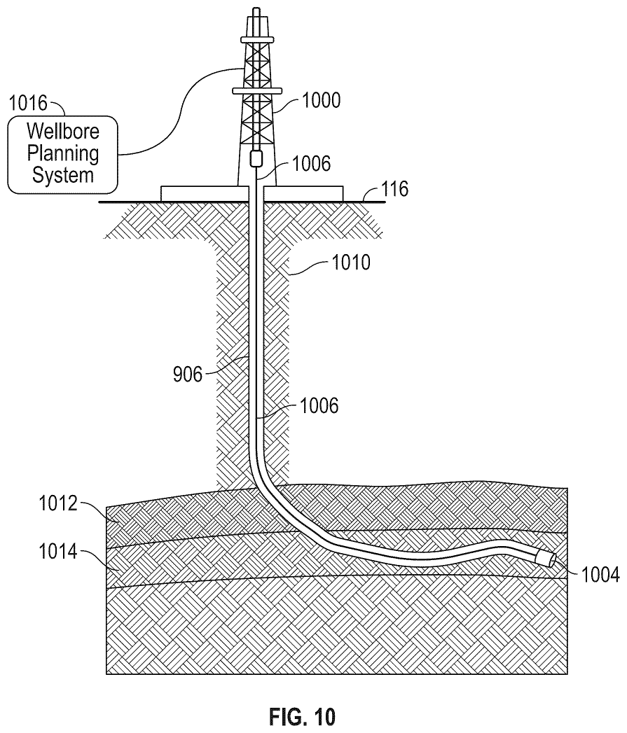

FIG. 10 depicts a wellbore drilling system in accordance with one or more embodiments. As shown in FIG. 10, a wellbore path (906) may be drilled by a drill bit (1004) attached by a drillstring (1006) to a drill rig (1000) located on the Earth's surface (116). The wellbore may traverse a plurality of overburden layers (1010) and one or more cap-rock layers (1012) to a hydrocarbon reservoir (1014). In accordance with one or more embodiments, an interpreted seismic image may be used to plan and drill a wellbore path (906). The wellbore path (906) may be a curved wellbore path, or a straight wellbore path. All or part of the wellbore path (906) may be vertical, and some wellbore paths may be deviated or have horizontal sections.

The seismic image may be used, together with other available information, to determine the location of a hydrocarbon reservoir within a subterranean region of interest with a high degree of certainty. Further, the seismic image may be used to determine locations within a hydrocarbon reservoir for which wellbores may be drilled, safely and economically, to produce the hydrocarbons.

Prior to the commencement of drilling, a wellbore plan may be generated. The wellbore plan may include a starting surface location of the wellbore, or a subsurface location within an existing wellbore, from which the wellbore may be drilled. Further, the wellbore plan may include a terminal location that may intersect with the targeted hydrocarbon bearing formation and a planned wellbore path (906) from the starting location to the terminal location.

Typically, the wellbore plan is generated based on best available information from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Furthermore, the wellbore plan may consider other engineering constraints such as the maximum wellbore curvature (“dog-log”) that the drillstring may tolerate and the maximum torque and drag values that the drilling system may tolerate.

A wellbore planning system (1016) may be used to generate the wellbore plan. The wellbore planning system (1016) may comprise one or more computer processors in communication with computer memory containing the geophysical and geomechanical models, information relating to drilling hazards, and the constraints imposed by the limitations of the drillstring and the drilling system. The wellbore planning system (1016) may further include dedicated software to determine the planned wellbore path (906) and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore.

Turning back to FIG. 10, a wellbore may be drilled using a drill rig (1000) that may be situated on a land drill site, an offshore platform, such as a jack-up rig, a semi-submersible, or a drill ship. The drill rig (1000) may be equipped with a hoisting system, which can raise or lower the drillstring and other tools required to drill the well. The drillstring may include one or more drill pipes connected to form conduit and a bottom hole assembly (BHA) disposed at the distal end of the drillstring. The BHA may include a drill bit (1004) to cut into subsurface rock. The BHA may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore. Both MWD and LWD measurements may be transmitted to the surface using any suitable telemetry system, such as mud-pulse or wired-drill pipe, known in the art.

To start drilling, or “spudding in” the well, the hoisting system lowers the drillstring suspended from the drill rig towards the planned surface location of the wellbore. An engine, such as a diesel engine, may be used to rotate the drillstring. The weight of the drillstring combined with the rotational motion enables the drill bit to bore the wellbore.

The near-surface is typically made up of loose or soft sediment or rock, so large diameter casing, e.g. “base pipe” or “conductor casing,” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface of the earth.

Drilling may continue without any casing once deeper more compact rock is reached. While drilling, drilling mud may be injected from the surface through the drill pipe. Drilling mud serves various purposes, including pressure equalization, removal of rock cuttings, or drill bit cooling and lubrication. At planned depth intervals, drilling may be paused and the drillstring withdrawn from the wellbore. Sections of casing may be connected and inserted and cemented into the wellbore. Casing string may be cemented in place by pumping cement and mud, separated by a “cementing plug,” from the surface through the drill pipe. The cementing plug and drilling mud force the cement through the drill pipe and into the annular space between the casing and the wellbore wall. Once the cement cures drilling may recommence. The drilling process is often performed in several stages. Therefore, the drilling and casing cycle may be repeated more than once, depending on the depth of the wellbore and the pressure on the wellbore walls from surrounding rock. Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

A drilling system may be disposed at and communicate with other systems in a well environment. The drilling system may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure WOB (weight on bit), RPM (drill rotational speed), GPM (flow rate of the mud pumps), and ROP (rate of penetration of the drilling operation). Each sensor may be positioned or configured to measure a desired physical stimulus. Drilling may be considered complete when a target zone is reached, or the presence of hydrocarbons is established.

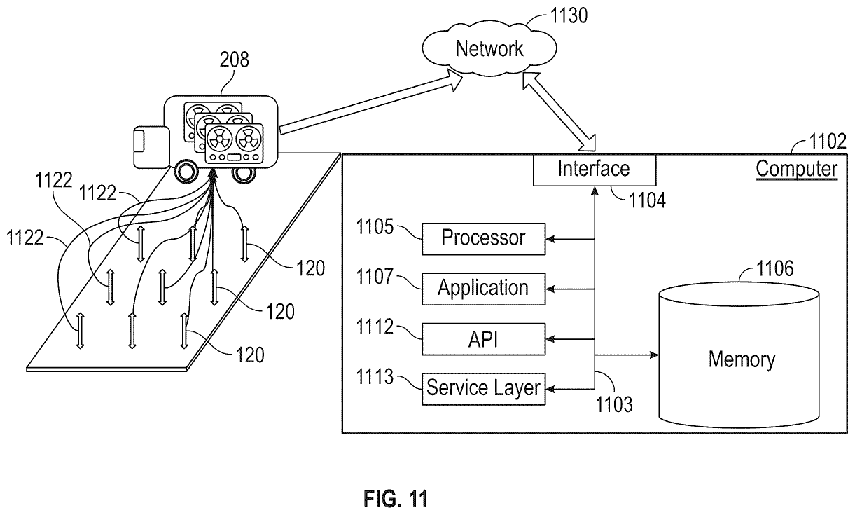

FIG. 11 shows a seismic acquisition system in accordance with one or more embodiments. The data recorded by a plurality of seismic receivers (120) may be transmitted to a seismic recording facility (208). The seismic recording facility (208) is often located in the vicinity of the seismic survey (100) but may be located remotely provided adequate communication bandwidth is available. The seismic recording facility may be one or more seismic recording trucks. The plurality of seismic receivers (120) may be in digital or analog telecommunication with the seismic recording facility (208). The telecommunication may be performed over telemetry channels (1122) that may be electrical cables, such as coaxial cables, or may be performed wireless using wireless systems, such as Wi-Fi or Bluetooth. Digitization of the seismic data may be performed at each seismic receiver (120), or at the seismic recording facility (208), or at an intermediate telemetry node (not shown) between the seismic receiver (120) and the seismic recording facility (208).

The seismic data may be recorded at the seismic recording facility (208) and stored on non-transitory computer memory. The computer memory may be one or more computer hard-drives, or one or more computer memory tapes, or any other convenient computer memory media familiar to one of ordinary skill in the art, without departing from the scope of the invention. The seismic data may be transmitted to a computer (1102) for processing. The computer (1102) may be located in or near the seismic recording facility (208) or may be located at a remote location, that may be in another city, country, or continent. The seismic data may be transmitted from the seismic recording facility (208) to a computer (1102) for processing. The transmission may occur over a network (1130) that may be a local area network using an ethernet or Wi-Fi system, or alternatively the network (1130) may be a wide area network using an internet or intranet service. Alternatively, seismic data may be transmitted over a network (1130) using satellite communication networks. Most commonly, because of its size, seismic data may be transmitted by physically transporting the computer memory, such as computer tapes or hard drives, in which the seismic data is stored from the seismic recording facility (208) to the location of the computer (1102) to be used for processing.

FIG. 11 further depicts a block diagram of a computer system used to provide computational functionalities associated with described algorithms, methods, functions, processes, flows, and procedures as described in this disclosure, according to one or more embodiments. In particular, FIG. 11 may include an ML engine for performing the methods described in the present disclosure.

The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130). In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application (for example, executing on another computer (1102) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure. A computer processor (1105) may be a central processing unit (CPU) or a graphics processing unit (GPU).

The computer (1102) also includes a memory (1106) that holds data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

In some embodiments, attribute generation from seismic data (such as Step 606 of FIG. 6) may be conducted using a first computer (1102) and one or more first applications (1107), while machine-learning prediction (such as Step 612 of FIG. 6), may be conducted on a second computer (1102) using one or more second applications (1107).

Although only a few example embodiments have been described in detail above, those skilled in the art will readily appreciate that many modifications are possible in the example embodiments without materially departing from this invention. Accordingly, all such modifications are intended to be included within the scope of this disclosure as limited only by the scope of the following claims.

What is claimed is:

1. A method, comprising:
obtaining a first surface seismic dataset of a subterranean region;
obtaining a measured seismic velocity profile through the subterranean region for a surface location;
determining a set of seismic attributes for the surface location from the first surface seismic dataset;
training, using the measured seismic velocity profile and the set of seismic attributes, a machine-learning network to predict a predicted seismic velocity profile from the set of seismic attributes, wherein the predicted seismic velocity profile is an estimate of the measured seismic velocity profile;
determining a set of seismic attribute volumes from a second surface seismic dataset; and
predicting a seismic velocity model for the subterranean region, using a trained machine-learning network and the set of seismic attribute volumes.

2. The method of claim 1, wherein the measured seismic velocity profile comprises a check-shot survey velocity profile.

3. The method of claim 1, wherein the set of seismic attribute volumes comprises a dip volume.

4. The method of claim 1, wherein the second surface seismic dataset comprises the first surface seismic dataset.

5. The method of claim 1, wherein the machine-learning network comprises Gaussian process regression.

6. The method of claim 1, wherein the seismic velocity model comprises an uncertainty estimate.

7. The method of claim 1, further comprising forming a depth-domain seismic image of the subterranean region based, at least in part, on the seismic velocity model.

8. The method of claim 7, wherein forming the depth-domain seismic image comprises determining a confidence interval for at least one depth in the depth-domain seismic image.

9. The method of claim 8, further comprising determining, using a seismic interpretation workstation, a location of a hydrocarbon reservoir based, at least in part, on the depth-domain seismic image.

10. The method of claim 9, further comprising planning, using a wellbore planning system, a wellbore path to intersect the hydrocarbon reservoir.

11. The method of claim 10, further comprising drilling, using a wellbore drilling system, a wellbore guided by the planned wellbore path.

12. A non-transitory computer readable medium storing a set of instructions, executable by a computer processor, the set of instructions comprising functionality for:
receiving a first surface seismic dataset of a subterranean region;
receiving a measured seismic velocity profile through the subterranean region for a surface location;
determining a set of seismic attributes for the surface location from the first surface seismic dataset;
training, using the measured seismic velocity profile and the set of seismic attributes, a machine-learning network to predict a predicted seismic velocity profile from the set of seismic attributes, wherein the predicted seismic velocity profile is an estimate of the measured seismic velocity profile;
determining a set of seismic attribute volumes from a second surface seismic dataset; and
predicting a seismic velocity model for the subterranean region, using a trained machine-learning network and the set of seismic attribute volumes.

13. The non-transitory computer readable medium of claim 12, further comprising forming a depth-domain seismic image of the subterranean region based, at least in part, on the seismic velocity model.

14. The non-transitory computer readable medium of claim 13, wherein forming the depth-domain seismic image comprises determining a confidence interval for at least one depth in the depth-domain seismic image.

15. The non-transitory computer readable medium of claim 13, further comprising:
determining, using a seismic interpretation workstation, a location of a hydrocarbon reservoir based, at least in part, on the depth-domain seismic image; and
planning, using a wellbore planning system, a wellbore path to intersect the hydrocarbon reservoir.

16. A system, comprising:
a seismic acquisition system configured to:
obtain a first surface seismic dataset of a subterranean region, and
obtain a second surface seismic dataset of the subterranean region; and
a computer system configured to:
receive the first surface seismic dataset,
receive a measured seismic velocity profile through the subterranean region for a surface location,
determine a set of seismic attributes for the surface location from the first surface seismic dataset,
train, using the measured seismic velocity profile and the set of seismic attributes, a machine-learning network to predict a predicted seismic velocity profile from the set of seismic attributes, wherein the predicted seismic velocity profile is an estimate of the measured seismic velocity profile,
determine a set of seismic attribute volumes from the second surface seismic dataset, and
predict a seismic velocity model for the subterranean region, using a trained machine-learning network and the set of seismic attribute volumes.

17. The system of claim 16, wherein the machine-learning network comprises Gaussian process regression.

18. The system of claim 17, further comprising forming a depth-domain seismic image of the subterranean region based, at least in part, on the seismic velocity model.

19. The system of claim 18, wherein forming the depth-domain seismic image comprises determining a confidence interval for at least one depth in the depth-domain seismic image.

20. The system of claim 18, further comprising:
a seismic interpretation workstation configured to determine a location of a hydrocarbon reservoir based, at least in part, on the depth-domain seismic image;
a wellbore planning system configured to plan a wellbore path to intersect the hydrocarbon reservoir; and
a wellbore drilling system configured to drill a wellbore guided by the planned wellbore path.
